(19) United States
(12) Patent Application Publication
(10) Pub. No.: US 2015/0204461 A1
(43) Pub. Date: Jul. 23, 2015

(54) Modular Plumbing Bracket

(71) Applicant: Mordehay Yakir Ben Jacov, Oakland, CA (US)

(72) Inventor: Mordehay Yakir Ben Jacov, Oakland, CA (US)

(21) Appl. No.: 14/674,941

(22) Filed: Mar. 31, 2015

Related U.S. Application Data
(63) Continuation-in-part of application No. 13/950,139, filed on Jul. 24, 2013.
Application No. 13/950,139 is a division of application No. 13/136,317, filed on Jul. 29, 2011, now abandoned.
(60) Provisional application No. 61/974,410, filed on Apr. 2, 2014.
(60) Provisional application No. 61/517,283, filed on Apr. 18, 2011.

(51) Int. Cl. F16L 3/10

(52) U.S. Cl. CPC F16L 3/1033; F16L 3/1091

(57) ABSTRACT

A plumbing support assembly for the installation of plumbing pipes in a building, comprising a support bracket to which at least one outlet pipe can be securely attached and at least one section of outlet pipe, said support bracket being capable of attaching to a building structure in a way that places the section of outlet pipe in the correct position for installing a plumbing fixture, said support bracket and section of outlet pipe being assembled together off-site. The support bracket may comprise a snap mount for the pipes, a screw mount for the pipes, or may be molded around the pipes.

### CROSS-REFERENCE TO RELATED APPLICATIONS

The present application claims the benefit of Provisional App. No. 61/974,410, filed Apr. 2, 2014, and is a continuation in part of application Ser. No. 13/950,139, filed Jul. 24, 2013, which is a divisional application of application Ser. No. 13/136,317, filed Jul. 29, 2011, which claims the benefit of Provisional App. No. 61/517,283, filed Apr. 18, 2011, which is hereby incorporated by reference in its entirety.

### BACKGROUND OF THE INVENTION

1. Field of the Invention

The present invention relates to plumbing fixtures, in particular to preassembled plumbing fixtures.

2. Description of the Prior Art

The installation of plumbing systems such as kitchen or bathroom sinks, toilets, or other plumbing fixtures and appliance outlets for residential, commercial, or industrial applications, typically requires the use of devices such as holders and straps to hold incoming and outgoing pipes to and from the plumbing fixture or appliance outlet. Typically, the way that plumbing systems are installed is by securing the plumbing pipes to the structure of the building (except in the case of underground plumbing, which is supported by the earth). The pipes are usually secured to the structure by straps and brackets. Temporary “rough-in” brackets may also be used during installation.

Since the precise location of an outlet pipe may be important for some applications, it is important to secure the outlet pipe in exactly the right location. Prior art devices enable the plumber to temporarily hold a pipe in place while it is being soldered. For example, U.S. Pat. No. 7,039,965 to Ismert discloses a bracket with holes and half-holes in it that is mounted on the studs of a building prior to the installation of any pipes. During installation, the plumber puts the pipes through the holes or half-holes to put them in the right relative or absolute position, and then solders them in place. However, the Ismert invention has a drawback in that it requires the plumber to assemble the bracket to the pipes on the building site, as there is no means of attaching the pipe to the bracket off-site (it must be soldered in place on-site). This takes time, and thus is expensive for the building owner and complicated for the plumber.

A system and method are therefore needed for assembling a plumbing outlet pipe to a bracket or support member off-site so that it can be attached to a wall stud or other building structure as a unit.

### SUMMARY OF THE INVENTION

An object of the present invention is to provide a plumbing outlet pipe assembly that can be easily installed in a building structure.

Another object of the present invention is to improve the precision of outlet pipe installation.

Another object of the present invention is to decrease the amount of plumbing work that has to be done on-site.

The present invention is a plumbing pipe assembly comprising at least one outlet pipe and a support bracket attached to the pipe. The support bracket comprises a pipe mount which is securely attached to the outlet pipe or pipes, and a stud mount that comprises at least one mounting hole for attaching the stud mount to a stud. The pipe mount and the stud mount are rigidly connected to each other.

The pipe mount may be attached to the outlet pipe in a removable fashion, or may be permanently attached. In an embodiment, the pipe mount is a snap mount, comprising two curved arms that snap around the pipe and hold it in place. The pipe mount may also be attached to the pipe with screws. In another embodiment, the pipe mount is actually molded around the pipe and permanently attached.

The pipe mount may be made of ABS plastic, HDPE, metal, or any other material that can support an outlet pipe or pipes. In the preferred embodiment, the pipe mount is made of ABS.

In an embodiment, two or more outlet pipes are attached to the bracket, wherein the bracket has two or more pipe mounts, said pipe mounts positioned in such a way as to put the outlet pipes at the right relative position for the installation of a plumbing fixture such as a toilet or a sink.

### BRIEF DESCRIPTION OF THE DRAWINGS

FIG. 1A shows an embodiment of the plumbing support assembly of the present invention using only one pipe and a snap bracket.

FIG. 1B shows an embodiment of the plumbing support assembly of the present invention using only one pipe and a snap bracket.

FIG. 2A shows an embodiment of the plumbing support assembly of the present invention using multiple pipes and a screw-together bracket.

FIG. 2B shows an exploded view of an embodiment of the plumbing support assembly of the present invention using multiple pipes and a screw-together bracket.

FIG. 2C shows an embodiment of the plumbing support assembly of the present invention using multiple pipes and a screw-together bracket.

FIG. 3 shows an embodiment of the plumbing support assembly of the present invention using multiple pipes and a molded bracket.

### DETAILED DESCRIPTION OF THE PREFERRED EMBODIMENT

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. All publications, patent applications, patents, and other references mentioned herein are incorporated herein by reference in their entirety. As used herein, the term “and/or” includes any and all combinations of one or more of the associated listed items.

A goal of the present invention is to provide a preassembled plumbing assembly, comprising at least one section of outlet pipe and a mounting bracket. The plumbing assembly may be assembled off-site and taken to the building site in its assembled condition. A plumber installing the plumbing in a building will then be able to simply attach the mounting bracket to the building structure and have the outlet pipe perfectly positioned. This saves time at the building site and therefore reduces plumbing labor expenses.

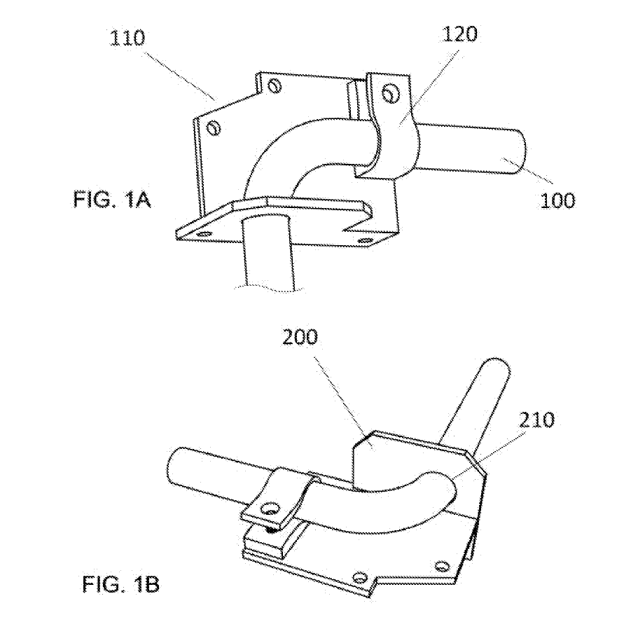

As is shown in FIGS. 1A and 1B, the plumbing assembly of the present invention comprises a section of outlet pipe 100 and a bracket 110. The outlet pipe is removably but securely attached to the bracket 110 by means of a pipe mount 120, which is preferably part of the bracket 110. In the preferred embodiment, the pipe mount 120 is a snap mount and is formed from the same material as the bracket 110. The outlet pipe snaps into the pipe mount and is held in place by the tension on the members of the pipe mount. The pipe mount is preferably made in such a way that a pipe can be snapped into it without breaking the members, and that the pipe is securely held in place without displacement once it is snapped in.

In alternate embodiments, two or more snap mounts may be used to secure the outlet pipe in place. The snap mounts may be located coaxially, or may be placed in any other way that would enable the pipe to be securely held in place.

In an embodiment, the free ends of the snap mount may be secured with a bolt or a screw or another fastener to hold the outlet pipe in place more securely once it is snapped in. For example, each free end of the snap mount may comprise a hole perpendicular to the outlet pipe, as shown in FIGS. 1A and 1B. A bolt and nut may then be passed through the two holes to tighten the snap mount securely around the pipe and to prevent the pipe from coming out of the snap mount.

In an embodiment, the bracket may also comprise other positioning features to hold the outlet pipe in place. For example, as shown in FIGS. 1A and 1B, a flange 200 with a hole 210 may be used to position the outlet pipe correctly and to prevent it from rotating. The hole 210 is preferably slightly larger than the outer diameter of the outlet pipe. The hole may also be an open cutout instead of a closed hole (not shown). More than one flange may be used for other embodiments.

The bracket is preferably attached to a stud in a building structure or to any other part of the building structure available for attachment. It may be attached to the structure by means of one or more wood screws passing through mounting holes in the bracket. In alternate embodiments, it may be attached to the structure by nails, nuts and bolts, or any other fasteners; or simply adhered to the structure by means of adhesives.

While the snap mount embodiment of the present invention shown here is intended for use with one pipe, other embodiments may comprise multiple snap mounts for use with multiple pipes.

In an embodiment, the bracket may have more than one outlet pipe attached to it. This is helpful for applications where the precise distance between outlet pipes or the precise relative position of the outlet pipes are important—for example, toilets or sinks. The pipe mounts are preferably mounted on the bracket at the proper relative distance to get the outlet pipes at the right relative position for the desired application. In an embodiment, some of the pipe mounts may be of a different size from other pipe mounts, to make it possible to attach different-sized outlet pipes to the same fixture. For example, the installation of a standard sink requires two outlet pipes for the faucets and one drain pipe, which is typically larger than the outlet pipes for the faucets. A bracket designed for a standard sink will therefore have two pipe mounts for the faucet outlet pipes, placed at the correct relative position for a standard sink, and a larger pipe mount for the drain pipe. Other bracket designs may be made available for toilets and other standard plumbing fixtures.

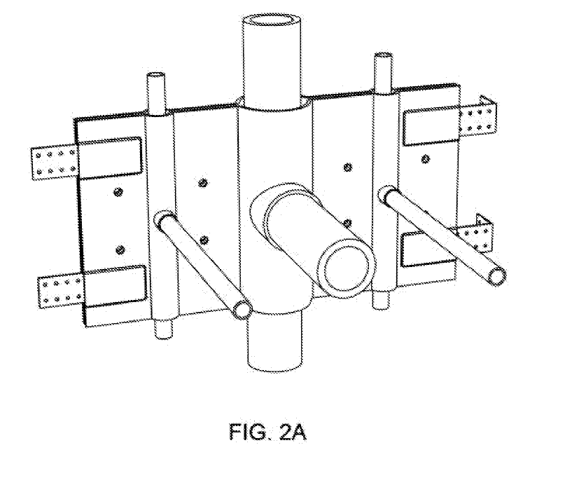

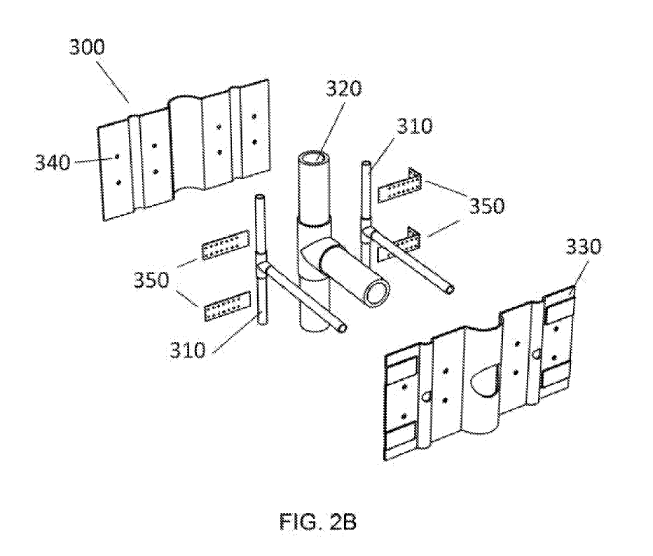

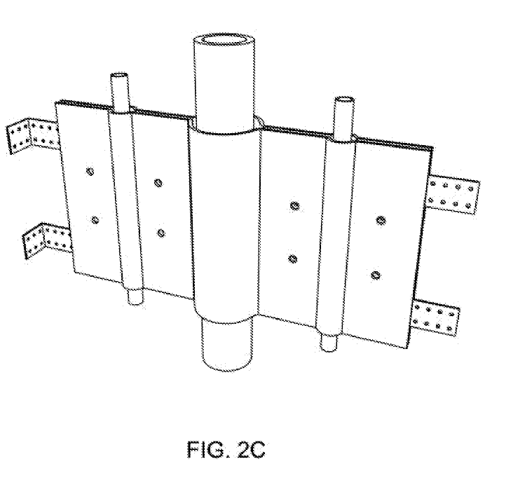

A bracket may comprise two parts that screw together or attach together in another way, as shown in FIGS. 2A-2C. The two-part bracket is a piece shaped to fit the pipe or pipes needed to be mounted on a building structure. FIG. 2B shows an exploded view of the two-part bracket. Back half 300 is shaped to fit the size and number of pipes the bracket is intended for. In the embodiment shown, the back half 300 is shaped for three pipes—two outlet pipes 310 and a drain pipe 320—for the installation of a sink. The relative location of the three pipes is such that a sink can be installed on these pipes. Front half 330 is also shaped to fit the size and number of pipes the bracket is intended for, and also comprises holes to fit the outlet pipes. Bolt holes 340 are provided to secure the front half to the back half after the pipes are placed in between the front half and the back half. In another embodiment, the front half is attached to the back half by means of adhesives. Mounting plates 350 are secured to the front half and the back half by means of bolt holes, and are used to attach the assembly to a building structure. The mounting plates may be straight or angled, depending on application. FIG. 2A shows the front view of an assembled bracket with three pipes in it; FIG. 2C shows the back view.

In an embodiment (not shown), a bracket may have multiple pipe mounts available for different plumbing fixtures, rendering it usable for several different applications. For example, the same bracket can have pipe mounts placed in the right relative positions for a sink and other pipe mounts placed in the right relative positions for a toilet.

In another embodiment (not shown), the position of the pipe mounts on the bracket may be adjustable. For example, the pipe mount may be attached by a screw and nut through a slot, thus making it movable within a certain range of motion. A user could then assemble the bracket and any outlet pipes and adjust the exact position of the outlet pipes for the needed application. The bracket and pipe assembly can then be delivered to the building site and mounted onto the building structure.

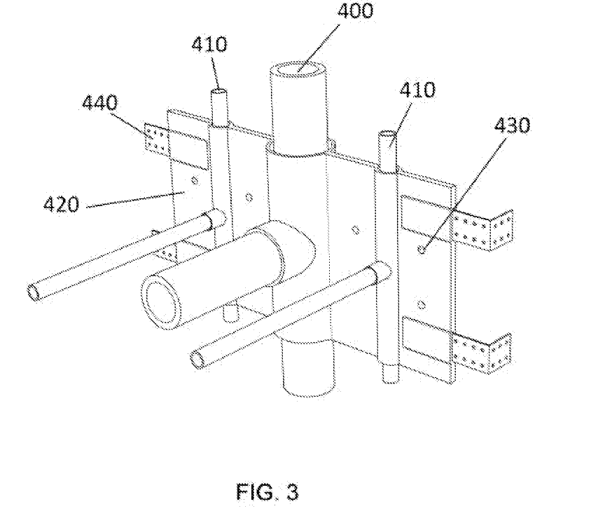

In an embodiment, the bracket may be molded plastic, molded around the pipe or pipes to keep the pipe or pipes in the correct relative position. The plastic may be ABS, HDPE, or any other plastic that is structurally sound, conforms to building codes, and can support the pipes in the correct position. FIG. 3 shows this embodiment for an application for the installation of a sink. Drain pipe 400 and outlet pipes 410 are embedded in a molded plastic bracket 420, which is shaped to place the pipes in the correct relative position for the installation of a sink. The molded plastic bracket also comprises mounting holes 430 and, in an embodiment, one or more mounting brackets 440, to attach the molded plastic bracket to a building structure. In an embodiment, the pipes comprise various features to keep them from shifting around once the plastic is molded around them, such as roughened surfaces, protrusions, dents, or other similar features.

In the above-described embodiment, the molded plastic can be any shape that can support the pipes in the correct position. It may be a bracket as shown in FIG. 3, a block of plastic, or any other shape that can be molded with standard plastic-molding tools and that is easy to attach to the structure of a building.

Exemplary embodiments are described above. It will be understood that the present invention encompasses all reasonable equivalents to the above-described embodiments, and that the only limitations on the present invention are the appended claims.

1. A plumbing pipe assembly, comprising:
at least one outlet pipe;
a support bracket, said support bracket comprising:
a pipe mount, said pipe mount rigidly attaching the at least one outlet pipe to the support bracket;
a stud mount, said stud mount comprising at least one mounting hole for mounting the support bracket to a building structure.

2. The plumbing pipe assembly of claim 1, wherein the pipe mount is permanently attached to the at least one outlet pipe.

3. The plumbing pipe assembly of claim 1, wherein the pipe mount is removably attached to the at least one outlet pipe.

4. The plumbing pipe assembly of claim 3, wherein the pipe mount is a snap mount.

5. The plumbing pipe assembly of claim 3, wherein the pipe mount comprises:
a pipe support bracket, said pipe support bracket shaped in a way that securely fits around the at least one outlet pipe;
wherein the pipe support bracket attaches to the stud mount with screws.

6. The plumbing pipe assembly of claim 3, wherein the pipe mount comprises:
a pipe support bracket, said pipe support bracket shaped in a way that securely fits around the at least one outlet pipe;
wherein the pipe support bracket attaches to the stud mount with adhesive.

7. The plumbing pipe assembly of claim 4, wherein the snap mount comprises a left curved arm and a right curved arm, each rigidly attached to the bracket at one end and free at another end, the left curved arm and the right curved arm being sections of an annulus, with a space between the free ends sufficient to admit an outlet pipe between the left curved arm and the right curved arm when the left curved arm and the right curved arm are flexed by an external force, and where the left curved arm and the right curved arm hold the outlet pipe in place when no external force is applied.

8. The plumbing pipe assembly of claim 4, wherein the snap mount comprises one curved arm, the curved arm being a section of an annulus, said curved arm rigidly attached to the bracket at one end and free at another end, with a space between the free end and the bracket being sufficient to admit an outlet pipe between the free end and the bracket, and where the curved arm holds the outlet pipe in place when no external force is applied.

9. The plumbing pipe assembly of claim 8, wherein the free end of the curved arm may be secured to the body of the bracket by a fastener after the outlet pipe is admitted between the free end and the bracket.

10. The plumbing pipe assembly of claim 7, wherein the free end of the left curved arm may be secured to the free end of the right curved arm by a fastener after the outlet pipe is admitted between the free end of the left curved arm and the free end of the right curved arm.

11. The plumbing pipe assembly of claim 1, wherein the support bracket is made of one of the following: sheetmetal, plastic.

12. The plumbing pipe assembly of claim 1, wherein the support bracket is a molded piece of plastic material, wherein the at least one outlet pipe is embedded within the molded piece of plastic material.

13. The plumbing pipe assembly of claim 12, wherein the at least one outlet pipe comprises features that prevent it from rotating or sliding within the molded piece of plastic material.

14. The plumbing pipe assembly of claim 13, wherein the features are one of the following group: protrusions, rough surfaces, grooves, pits.

15. The plumbing pipe assembly of claim 1, comprising at least two outlet pipes, wherein the support bracket comprises at least two pipe mounts, the number of pipe mounts equal to or greater the number of outlet pipes, said pipe mounts placed in such a way as to position the outlet pipes appropriately for the installation of a standard plumbing fixture.

16. The plumbing pipe assembly of claim 15, where the standard plumbing fixture is a sink.

17. The plumbing pipe assembly of claim 15, where the standard plumbing fixture is a toilet.

18. The plumbing pipe assembly of claim 1, wherein the stud mount is removably attached to the pipe mount.

19. The plumbing pipe assembly of claim 12, wherein the stud mount comprises at least one metal plate, said metal plate comprising mounting holes sufficient for mounting the assembly to a building structure, said metal plate partially embedded in the molded piece of plastic material.
